(19) United States
(12) Patent Application Publication
(10) Pub. No.: US 2010/0146411 A1
(43) Pub. Date: Jun. 10, 2010

(54) GRAPHICAL USER INTERFACE

(76) Inventors: Ian Shaw Burnett, Victoria (AU); Stephen James Davis, New South Wales (AU); Gerrard Mathew Drury, New South Wales (AU)

Correspondence Address: LAW OFFICES OF MICHAEL M. AHMADSHAHI, 600 ANTON BLVD., STE. 1100, COSTA MESA, CA, 92626, US

(21) Appl. No.: 12/449,905

(22) PCT Filed: Mar. 3, 2008
(86) PCT No.: PCT/AU2008/000301

§ 371 Date: Feb. 16, 2010

Related U.S. Application Data
(60) Provisional application No. 60/892,593, filed on Mar. 2, 2007.

(51) Int. Cl. G06F 3/048; G06F 3/01

(52) U.S. Cl. 715/760; 715/781

(57) ABSTRACT

The present invention provides a graphical user interface for displaying content. The user interface comprises a list of display areas, including a first display area arranged to display a primary time based media element. The at least one second display area is arranged to display at least one secondary media element that is temporally associated with the primary time based media element.

### FIELD OF THE INVENTION

The present invention relates to a graphical user interface capable of displaying disparate content contemporaneously. The invention finds particular, but not exclusive, use when utilising a content delivery system described in a co-pending application in the names of Ian Shaw Burnett, Stephen James Davis and Gerrard Mathew Drury (assigned to Enikos Pty Ltd, an Australian company), entitled “A Method and System for Content Delivery”, filed on 2 Mar. 2007 as a provisional patent application before the United States Patent and Trademark Office.

### BACKGROUND OF THE INVENTION

More sophisticated methods of delivering content across a computer network are being developed. However, for many users, it remains difficult to create, publish or deliver such content in a sophisticated and effective manner.

Many tools, such as webpage/website authoring software, image processing software, and even ‘on-line’ website authoring tools are cumbersome to use and either have limited functionality or, at the other extreme, require the user to have intimate knowledge of Internet standards, protocols and design principles.

### SUMMARY OF THE INVENTION

In a first aspect, the present invention provides a graphical user interface for displaying content, comprising at least two display areas, including a first display area arranged to display a primary time based media element, and at least one second display area arranged to display at least one secondary media element that is temporally associated with the primary time based media element.

The graphical user interface may further comprise a third display area, arranged to display annotations which are temporally associated with the time based media element displayed in the first display area.

A plurality of additional display areas may be provided, each display area being arranged to display at least one additional media element.

At least one of the additional display areas may be arranged to display at least one additional media element which is temporally associated with the primary media element.

The user interface may be constructed utilising an information set, the information set including information regarding at least one of the temporal associations of the secondary and/or additional media elements to the primary media element.

The user interface may further comprise a timing command arranged to poll the information set at predetermined time intervals, to determine whether further secondary media elements and/or additional media elements should be displayed, and may also include a retrieval command arranged to access the information set to retrieve a locator for the at least one of the primary media element, the at least one secondary media element or the at least one tertiary media element.

The information set may include information regarding a plurality of discrete timing information sets, each timing information set operating independently of each other timing information set.

Each one of the plurality of timing information sets may be associated with at least one of the at least one secondary or additional media elements. The timing information set may include instructions to invoke a further timing information set.

The graphical user interface may include a search facility arranged to search the information sets to locate a particular primary, secondary or additional element.

The user interface may be downloaded as a file which is capable of being executed by web browsing software. The file may include Hyper-Text Mark-up Language (HTML) and JavaScript programming information capable of interpretation by web browsing software and may be written in programming code including Asynchronous JavaScript and XML (AJAX) techniques.

The user interface may also be a widget arranged to be included in a webpage.

The information set may be located at a remote location from the user interface. At least one of the primary media element, at least one secondary media element and at least one additional media element may also be located on a remote server.

The primary media element may be one of a video and an audio file and the at least one secondary media element or additional media element may be any one of a video file, an audio file, a text file and a web page.

In a second aspect, the present invention provides a method of providing a graphical user interface for displaying content, comprising the steps of providing at least two display areas, including a first display area arranged to display a primary time based media element, and at least one second display area arranged to display at least one secondary media element that is temporally associated with the primary time based media element.

In a third aspect, the present invention provides a computer program arranged to, when executed on a computing system, carry out the method steps in accordance with the second aspect of the invention.

In a fourth aspect, the present invention provides a computer readable medium incorporating a computer program in accordance with a third aspect of the invention.

### DETAILED DESCRIPTION OF THE DRAWINGS

Notwithstanding any other forms which may fall within the scope of the present invention, a preferred embodiment will now be described, by way of example only, with reference to the accompanying drawings in which:

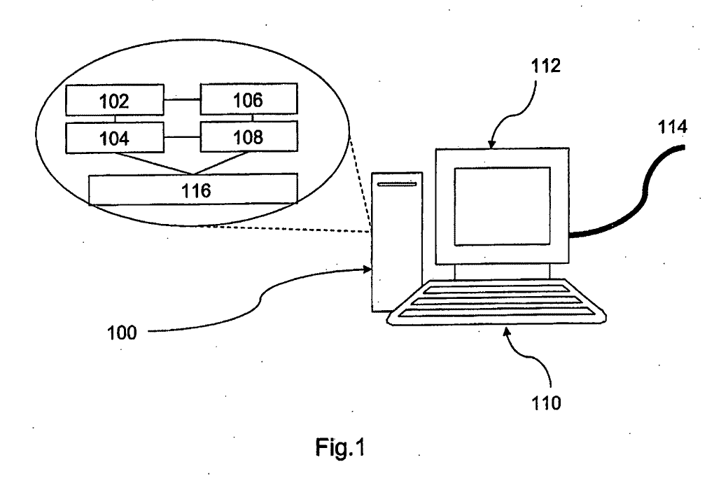

FIG. 1 is a diagram illustrating a computing system suitable for implementing a methodology or system in accordance with an embodiment of the present invention;

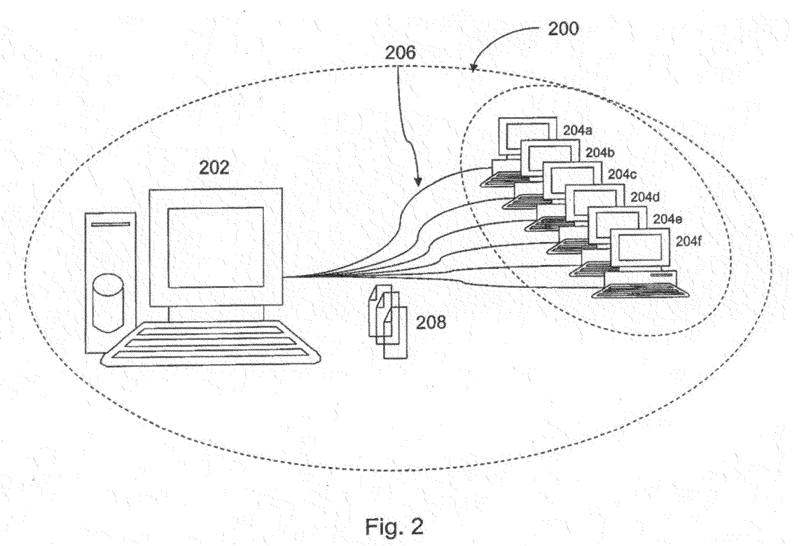

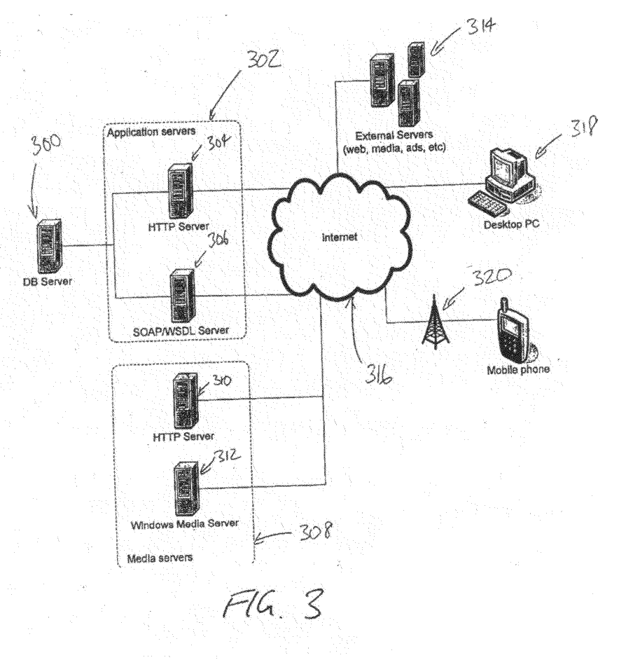

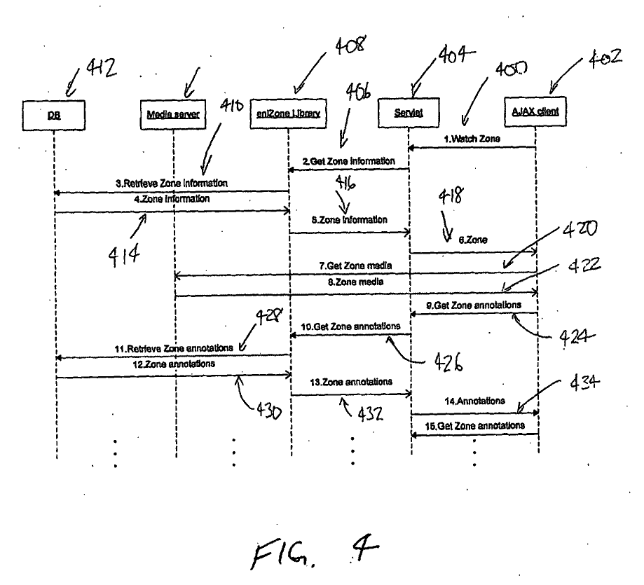

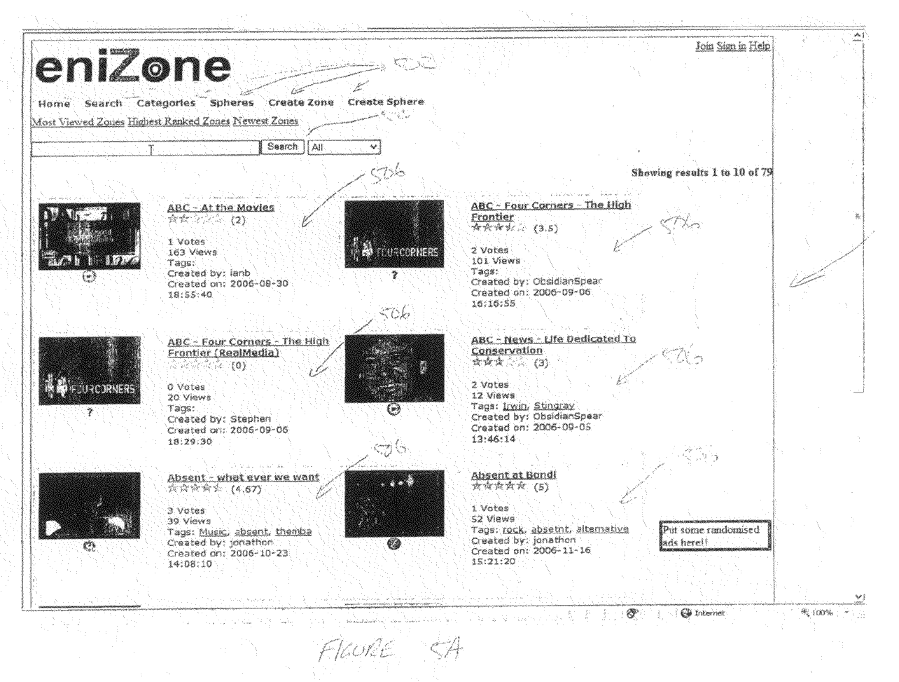

FIG. 2 is a diagram illustrating a computer network suitable for implementing a methodology or system in accordance with an embodiment of the present invention;

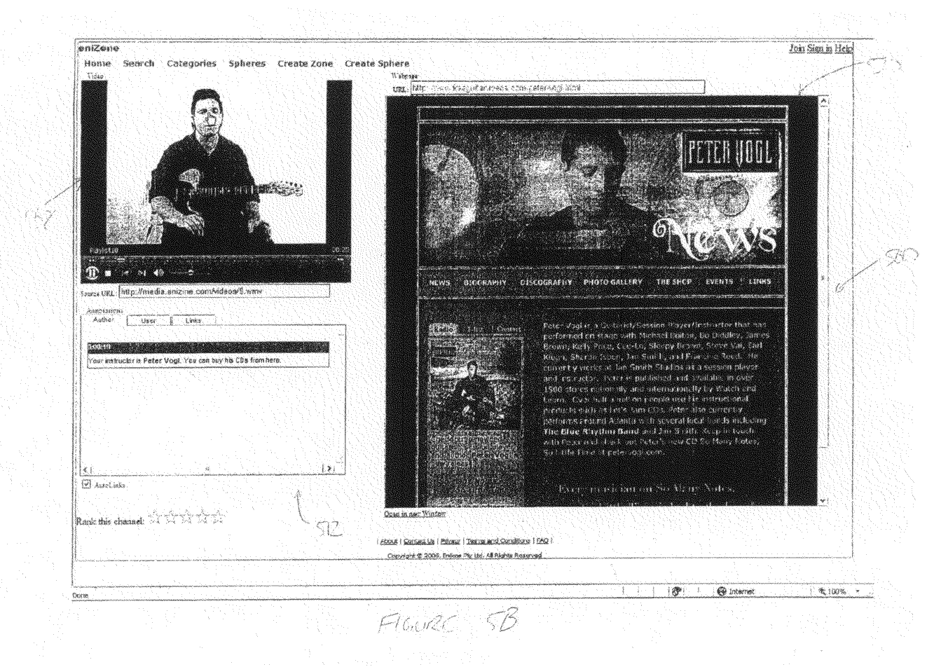

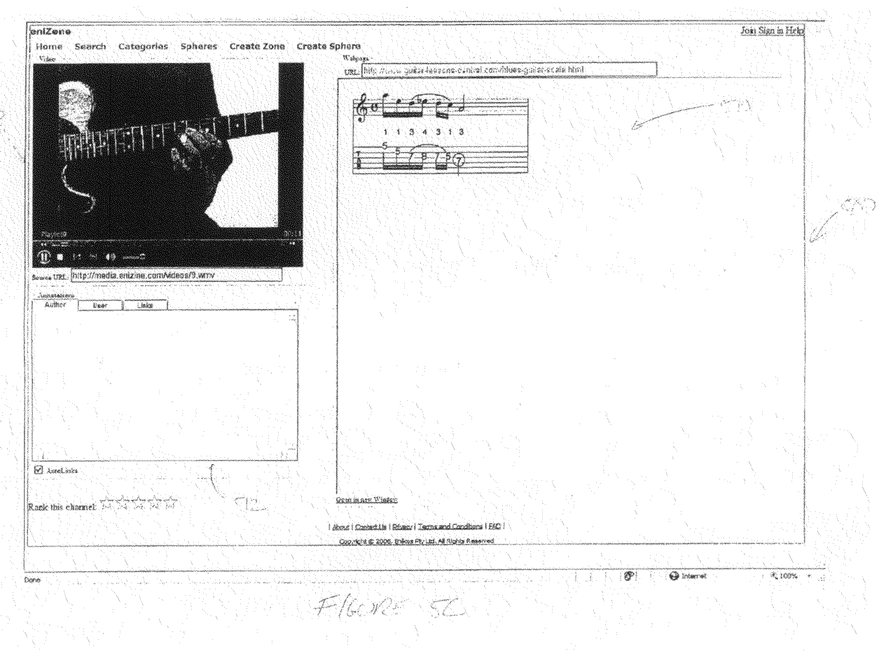

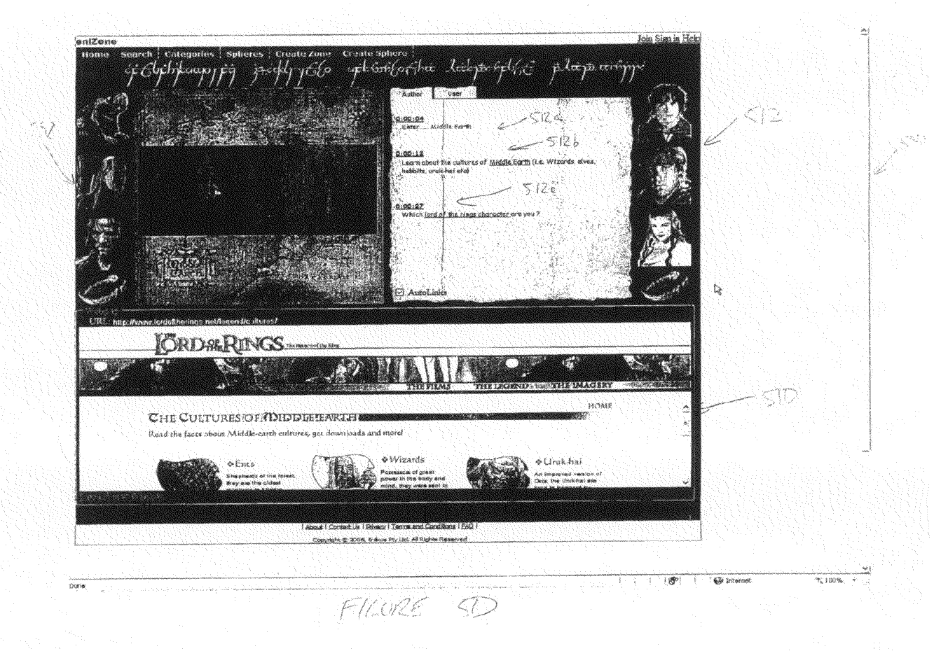

FIG. 3 is a system in accordance with an embodiment of the present invention;

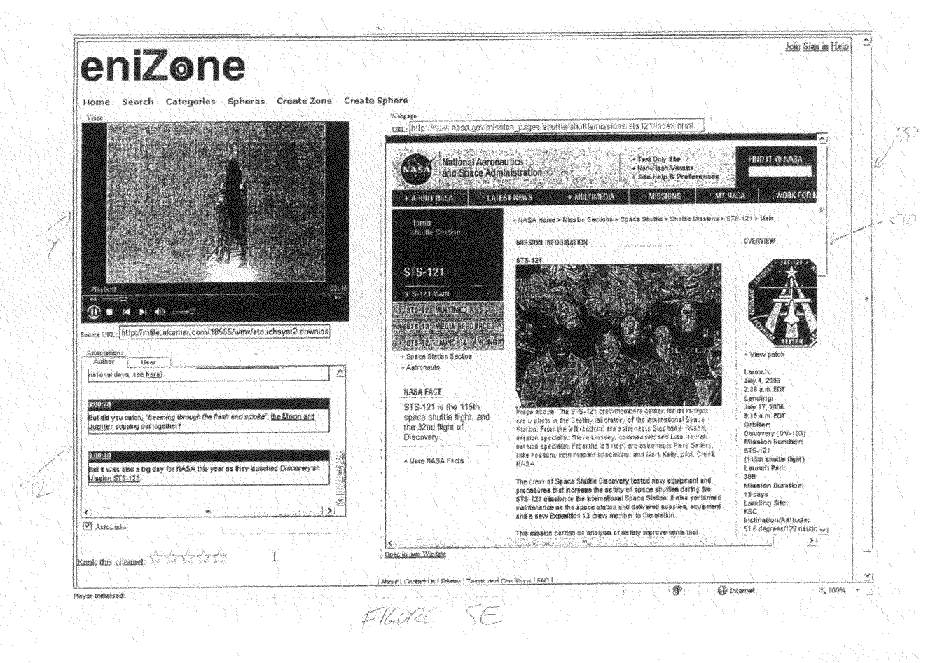

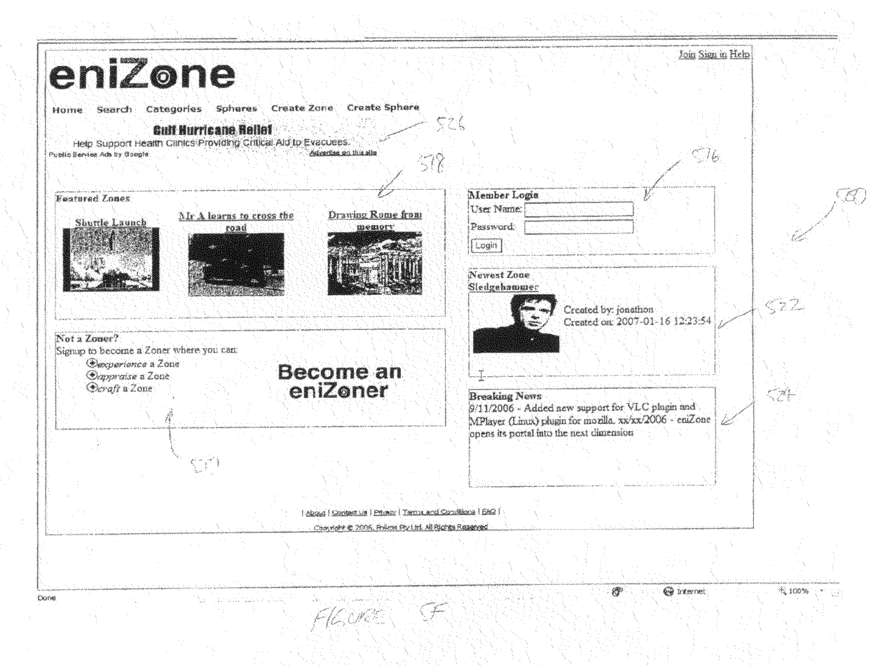

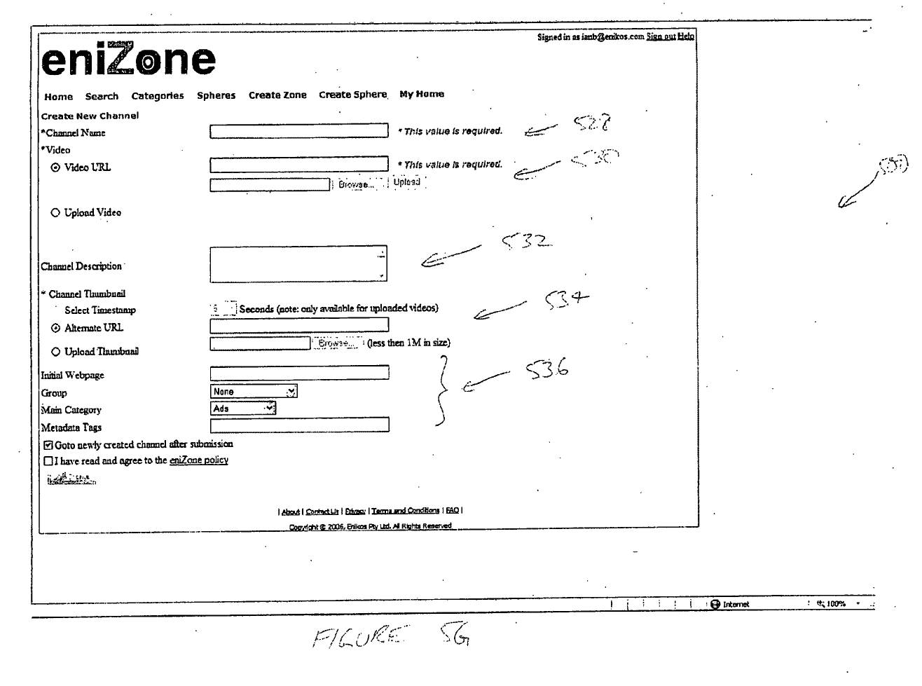

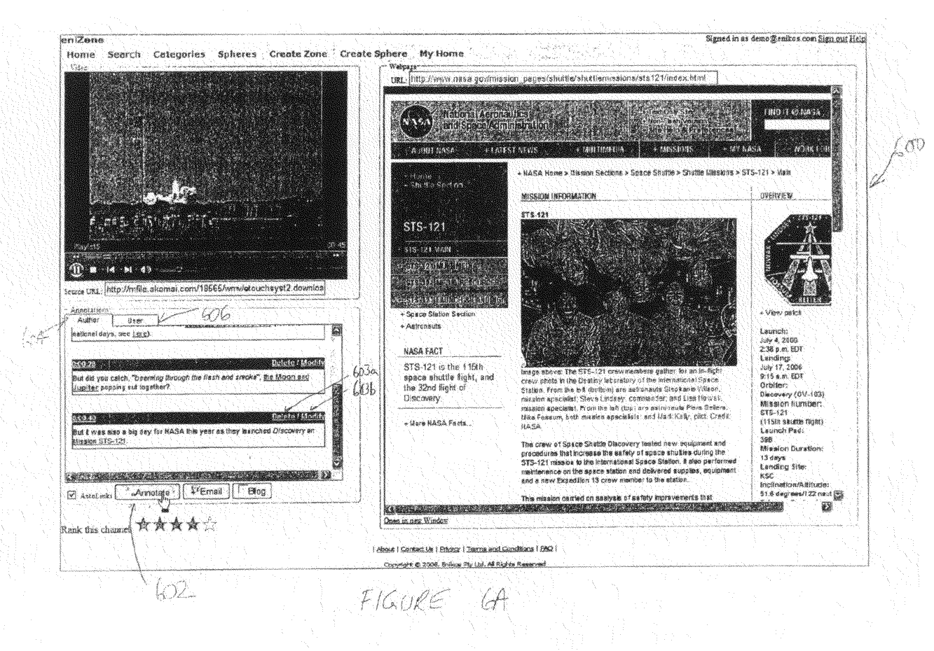

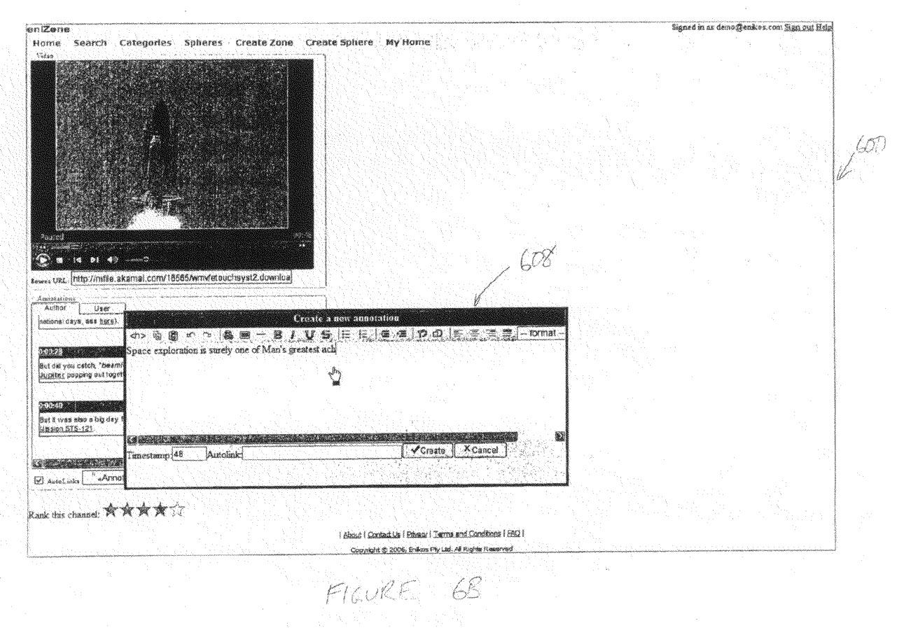

FIG. 4 illustrates the method steps in accordance with an embodiment of the present invention; FIGS. 5a-5g are screen captures of a graphical user interface in accordance with an embodiment of the present invention; and

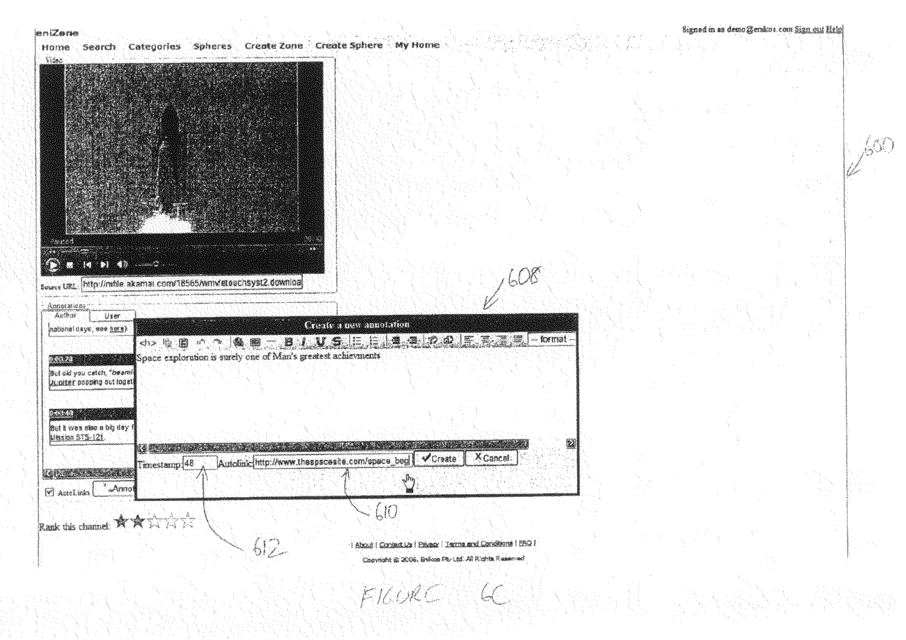

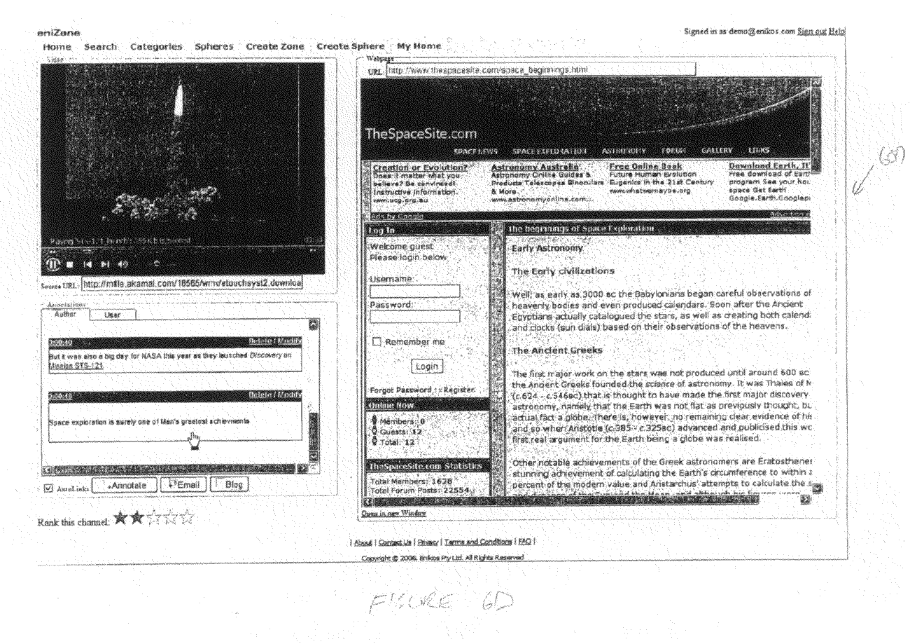

FIG. 6a-6d are screen captures of a graphical user interface in accordance with an embodiment of the present invention.

### DESCRIPTION OF SPECIFIC EMBODIMENTS

### Overview

The user interface (as embodied in a software application or in a mark-up language or other interpreted language) in accordance with an embodiment of the invention may be executed on a computing system such as the example computing system shown in FIG. 1. At FIG. 1 there is shown a schematic diagram of a computing system 100 suitable for use with an embodiment of the present invention. The computing system 100 may be used to execute applications and/or system services such as deployment services in accordance with an embodiment of the present invention. The computing system 100 preferably comprises a processor 102, read only memory (ROM) 104, random access memory (RAM) 106, and input/output devices such as disk drives 108, keyboard 110 (or other input peripherals such as a mouse, not shown), display 112 (or other output peripherals such as a printer, not shown) and communications link 114. The computer includes programs that may be stored in ROM 104, RAM 106, or disk drives 108 and may be executed by the processor 102. The communications link 114 connects to a computer network but could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system, such as Microsoft Windows™ or, Apple OS-X™ or Unix™. The computing system 100 may be a server arranged to send information to one or more client computers. The computing system 100 may be capable of executing a software application 116 (which may be in the form of an API) in accordance with an embodiment of the invention.

It will be understood that the computing system described in the preceding paragraphs is illustrative only and that the presently described embodiment or other embodiments which fall within the scope of the claims of the present application may be executed on any suitable computing system, which in turn may be realized utilizing any suitable hardware and/or software. Other computing systems that may be suitable include server computers, hand-held or portable computing devices, consumer electronics, and other devices capable of receiving electronic information, including automated ‘teller’ machines and vending machines.

FIG. 2 illustrates an example network environment 200, with a server computer 202 in communication with client computers 204a, 204b, 204c, etc., via a network (or a bus) 206, in which an embodiment of the present invention may be employed. In more detail, the server 202 may be a server including a database arranged to provide information to a number of client machines 204a, 204b, 204c, etc., via the communications network 206, which may be a local or wide area network, such as an intranet, the Internet, etc. It will be understood that the client computers need not be client machines, but may be a terminal, another computing system, a portable communications device, such as a mobile telephone, or any other device capable of receiving information from the server.

The server 202, and the client devices 204a, 204b, 204c, etc., may communicate with each other over the communications network 206 by use of any suitable networking protocol, such as TCP/IP or any other suitable protocol for the exchange of information 208. The exchange of information may include the provision of XML, HTML or other mark-up language files, the files providing information to be utilized and rendered in a user interface by any or all of the servers and client devices.

The embodiment described provides a user interface which displays temporarily associated disparate content in a logical and coordinated manner.

The system utilised to temporarily associate and deliver the content is known as “eniZone”, a product which allows media from diverse sources to be temporarily and temporally associated for display in a user interface in accordance with the embodiment described herein. The system provides a flexible framework such that content may be aggregated and deployed in a variety of environments.

A primary media type, which is generally a video or audio file (but could be any suitable temporal media), is displayed in a conventional web browser, which in turn may utilise any available ‘plug-in’ or other application or program to display the primary media type. For example, the ‘plug-in’ may be Realplayer™, Microsoft Media Player™ or a Java application arranged to display temporal media.

Additional media content (which may be any type of content, such as text, a webpage, a file, another video, an audio file, etc.) are associated with the primary media, so that on playback of the primary media, the additional content may be shown in conjunction with the primary media.

The user interface also displays the additional content in the web browser, or adjacent to the web browser (i.e. in the same ‘screen’ as the primary media). The user interface is arranged to display the additional content during a particular time sub interval of the primary media, so that the sequence in which the additional content is presented to the end user is controlled.

In order to access the media and the additional content, a user firstly accesses the user interface, which, in the embodiment described herein, is rendered in a web browser (such as Microsoft Internet Explorer™ or Mozilla™ Firefox™) as an interactive webpage. The webpage utilises AJAX (Asynchronous JavaScript and XML), a web development technique for creating interactive web applications.

The AJAX enabled webpage accesses the media by firstly accessing an intermediary server known as an “eniZone” server. The eniZone server contains information regarding the location of the relevant media, and also further temporal information which determines the time and order in which the additional media is displayed. In more detail, the web browser includes, in the URL, a call (request) which connects to a servlet (i.e. a Java application residing on a web server, which receives a request from JavaScript embedded in a webpage, processes the request, and returns a response). The servlet then responds with XML which contains the required information to construct the webpage and access the requisite primary and additional media elements.

One embodiment utilises a standard desktop web browser. In addition to accessing an eniZone ‘enabled’ website in the conventional manner, a user may also access a website which contains an eniZone ‘widget’, which is a small section or script of web standard code (such as HTML or JavaScript) that is embedded in another website, such as MySpace.

Of course, it will be understood that the user interface described herein may be utilised to deliver content to other computing devices, such as mobile phones, television set top boxes, etc.

### EniZone System Overview

In order to better understand the eniZone user interface, it is instructive to initially describe the eniZone system, which is the subject of a co-pending patent application, entitled “A System and Method for Delivering Content”.

FIG. 3 is a schematic drawing illustrating a system in accordance with one embodiment of the present invention.

The system includes a database server 300 which hosts the database containing the eniZone system information. The information may be divided into sets, the sets including user information, group information, category information, tag information, advertising information and Zone information.

The system also includes one or more application servers (302) which provide an interface between the database server 300 and the end user. FIG. 3 depicts two example application servers which are utilised with the embodiment described herein, including a HTTP server 304 and a SOAP/WSDL server 306.

Other application servers can be added to the system as required for providing access to the eniZone system from other client platforms.

The client side interface of each application server will be specific to the client platform(s) the application server is intended to serve. However, each application server utilizes a common eniZone server library for providing the functionality accessed via the application server.

The system also includes one or more media servers 308 to host and serve media content that is uploaded to the eniZone system.

FIG. 3 depicts two example media servers, namely a HTTP server 310 and a Windows Media server 312.

It will be understood that specialized media servers may be added to the system for handling specific media types, and the system is arranged to receive a large number of different media types, including images, video, audio, and any other type of suitable media.

In addition to servers which make up part of the system, the system may also access third party (external) servers 314 to utilise content hosted on the third party servers. That is, the media does not need to reside on media servers within the eniZone system but can be sourced from any location for which a URL for the media exists. Such media can include video, audio, images, text, web content, etc.

Third party servers 314 are also utilized by the eniZone system for supplementary information such as advertising material.

The servers (300-314) will generally be connected together through a suitable network, such as the one described with reference to FIG. 2. In the embodiment described herein, the network is the Internet 316, which is arranged to deliver information to personal computers 318 although it will be understood that the system may also deliver information to other telecommunications networks, such as a mobile telephone network 320 so that a mobile device user may access the system through a mobile device 322.

While FIG. 3 describes one particular embodiment of the invention, it will be understood, however, that the system can be deployed with any one of a number of configurations.

### EniZone Server Library

Referring to FIG. 4, there is shown a message flow diagram which depicts the method steps carried out by the system components of FIG. 3, when a request is made to the eniZone server library.

Each application server (depicted in FIG. 3 generally by numeral 302) includes an eniZone application server. A client (i.e. a user, through a browser or other suitable software) makes a request 400 via a client-side interface 402 (i.e. a browser, or more specifically, in the embodiment described herein, an AJAX (Asynchronous JavaScript and XML) client operating within a browser)) of an application server 404 and the application server then calls 406 upon the eniZone server library 408 to execute the request and provide a response.

In more detail, the client 402 is the eniZone AJAX client running in a standard web browser and the application server is an HTTP server that presents a Java servlet interface 404 to the eniZone library 408. The method steps followed by the system are as follows:
1. The user clicks on a hyperlink in their web browser to watch a Zone. The eniZone AJAX client 402 makes a watch Zone call 400 to the eniZone servlet 404 running on the HTTP server (not shown).
2. The eniZone servlet 404 processes the client request by in turn requesting the Zone information 406 by a call to the eniZone library 408.
3. The eniZone library retrieves the Zone information 410 from the database (DB) 412.
4. The Zone information is returned 414 to the eniZone library 408 as rows of data from tables in the database 412.
5. The Zone information is returned 416 to the eniZone servlet 404 as XML.
6. The Zone information is returned 418 to the eniZone AJAX client 402 which then presents the Zone to the user.
7. The Zone information includes a URL for the Zone media. The eniZone AJAX client 402 selects an appropriate media player plug-in based on the media type, and passes the media URL to the media player plug-in. The media player plug-in then retrieves the media from the media server via this URL (420). The media server could be either a media server internal to the eniZone system or an external server.
8. The Zone media is returned to the media player plug-in running in the web browser 422. The media continues to play in the media player plug-in subject to control of the eniZone AJAX client and/or the user.
9. As the media is playing, the eniZone AJAX client makes a get Zone annotations call 424 to the eniZone servlet 404. The call requests annotations for a specified block of time within the timeline of the Zone.
10. The eniZone servlet processes the client request by in turn requesting 426 the block of Zone annotations by a call to the eniZone library 408.
11. The eniZone library retrieves 428 the annotation information from the database 412.
12. The annotation information is returned 430 to the eniZone library as rows of data from tables in the database 412.
13. The annotation information is returned 432 to the eniZone servlet 404 as XML.
14. The annotation information is returned 434 to the eniZone AJAX client 402 which then presents the annotations to the user.

Steps 9 to 14 are repeated for the duration of the Zone timeline while the Zone media is playing. As required, other client platforms can be supported by using alternate client and/or application server technologies. For example, instead of directly using the eniZone servlet, the application server could present a SOAP/WSDL interface to the eniZone library.

An alternative client application utilizing the SOAP/WSDL interface (e.g. a Java based application for mobile phone applications) would be used to deliver information to the user from the database and media server. Although the interface presented by the application server has changed and the client applications are different, the eniZone server library remains the same for both application servers.

### Functional Specification—the EniZone Library and Widgets

The eniZone library (depicted in FIG. 4 as block 408) provides the functionality for storing and retrieving information in the eniZone system that is used by the user interface to create the eniZone experience for the user. An example of the calls available in the eniZone library are shown in Appendices A and B respectively. Appendix A outlines a set of ‘core’ calls that are used to query the eniZone library. Appendix B outlines a set of ‘core’ calls that are used to construct ‘widgets’, which are small sections of HTML/JavaScript code which may be embedded into conventional HTML web pages. The ‘widgets’ allow for the functionality of eniZone to be incorporated into existing websites, such as MySpace, or a user's personal website.

An end user does not need to be aware of the technology that underlies the eniZone library, as the user interacts with the eniZone library through a conventional web browser. For example, a user may load an eniZone page by simply typing an appropriate URL into their browser. For example, to load a Zone with Zone id of 12, the user would type:

http://www.eniZone.com/WatchZone.php?c=12

Moreover, an end user creating a ‘Zone’ need not have any formal knowledge of programming or of the underlying technology of eniZone. An end user may simply access their eniZone site through a conventional web browser, which will guide them through the creation of an eniZone page.

### The Graphical User Interface

Referring now to FIGS. 5a-5h (where like numerals are utilised to denote like components), there is described a graphical user interface 500 in accordance with an embodiment of the present invention.

The graphical user interface 500 of FIG. 5a is a ‘front page’ which is viewable when a user initially accesses an eniZone enabled website. The front page contains a number of option buttons 502 arranged along a top portion of the screen, and a search facility 504, which allows a user to conduct keyword searches. The front page also contains a series of ‘summary boxes’ 506, which display a summary or snapshot of each of a plurality of ‘Zones’. A ‘Zone’ is defined as a particular instance (i.e. webpage or website) which temporarily and temporally associates content for display to a user.

To access a Zone, a user may click on the summary box 506, which then takes the user to a webpage/website as shown in FIG. 5b. The webpage 500 (user interface) of FIG. 5b includes a first area 508 arranged to display a primary media element. As described above, the primary media element is a time based element, which may be a video file, an audio file, or any other dynamic presentation which is arranged to be displayed for a determined period of time (e.g. a live stream). The webpage 500 also includes a second area 510 arranged to display a secondary media element during a defined interval in the playing of the primary media element. In the example of FIG. 5b, a website belonging to Peter Vogl, a guitarist, is displayed in the second area 510 while a video of Peter giving a guitar lesson plays in first area 508.

Referring to FIG. 5c, at a later time during play of the same video (i.e. when a close-up of the strings of the guitar are shown), a new website is displayed in second area 510, despite the same video being shown in the first area 508.

In other words, while the primary media element in first area 508 remains the same, a plurality of secondary media elements can be displayed in the second area 510, as the video displayed in the first area 508 progresses along a time line.

Moreover, additional areas, which are also temporally associated with the primary area, may be provided. In the example of FIGS. 5b and 5c, a further area 512 is provided, which is used to display comments, annotations or other information, such as textual, XHTML, or HTML information. The additional area allows the user to also review or view additional material in any suitable format.

It will be understood that in other embodiments (not shown here) further additional areas may be provided, such as an area which displays context driven advertising, or areas that display further websites/text, or indeed any further media as dictated by the creator of a Zone. The embodiment described herein is not limited to providing only three areas where information may be displayed.

Referring now to FIG. 5d, there is shown a further example of a Zone, which has been customised to display the content in a manner which is more appealing to the user. The user interface of FIG. 5d maintains the concept of displaying, in a first area, a primary media element 508, which in this example, is a video. There is also provided, along the lower half of the user interface, a second area for displaying a secondary media element 510, which in the example of FIG. 5d, is a webpage which is relevant to the video shown in the first area 508.

There is also provided an additional area 512, which in the present example provides a user with the ability to add or view annotations, the annotations being arranged to appear at predetermined time intervals during the display of the primary media element. As can be seen from the markers 512a, 512b and 512c, the annotations are linked to a particular time during display of the primary media element. For example, the first marker 512a provides an annotation which is displayed at the 4 second mark during display of the primary media element. It will be understood that the term ‘annotation’ should be construed broadly to include any relevant information, including author comments, third party comments, information generated by any party, including a software application, or any other information. The annotations may be provided in a textual format, or may also be provided in any suitable audible, visible or perceptible (including tactile and olfactory) manner.

FIG. 5e provides yet another example of a user interface in accordance with the embodiment described herein.

Each of the example user interfaces shown in FIGS. 5b, 5c, 5d and 5e may also include further information, such as a ‘ranking’ 514. The ranking 514 represents a user's opinion on the usefulness, ‘coolness’ or general ‘interestingness’ of a Zone. Such additional tools may be used as desired, and the addition of additional tools, controls, or other interface devices is within the purview of a person skilled in the art.

Referring now to FIG. 5f, there is shown a login page which may be accessed by a user to thereby allow access to restricted or private Zones (or groups of Zones), content, or editing features.

A user may log into the user interface by providing a username and password at login box 516. The login page may also contain further material, such as examples of available Zones 518, a signup page 520 (which allows a non-user to become a user), listings of new Zones 522 and/or news updates 524, advertising 526, or any other information as required.

Referring now to FIG. 5g, there is shown a Zone setup webpage. The Zone setup page allows a user to setup a Zone (i.e. an instance of the user interface). The Zone setup page is arranged to be easy and intuitive to use, such that even users with only a rudimentary knowledge of computing and the Internet should be capable of setting up a Zone.

The setup page requires a user to set a name for the Zone 528, link the Zone to a primary media element (for example, a video file or an audio file) or alternatively, upload a primary media element 530, provide a description of the Zone 532, select a thumbnail which represents the Zone 534, and provide some additional information 536 to uniquely identify the Zone. Once this information has been entered, a basic Zone is created.

Referring to FIGS. 6a to 6g, there is shown, through a series of screen shots, the method steps by which a user may associate secondary and additional media elements in a temporal manner with the primary media element. Each screen shot represents a zone 600 (i.e. an instance of the user interface).

At FIG. 6a, a user utilises the “Annotate” button 602, which is only available if the user is logged into the system. If the user is the original author (i.e. the owner of the original annotation) “Modify” and “Delete” buttons (shown as hyperlinks 603a and 603b) are also available.

Moreover, if the user adding the annotation is the creator of the Zone, then any annotations made will be added to the “Author” annotations tab pane 604. Otherwise, the annotations they be added to the “User” annotations tab pane 606.

It will be understood that the particular example of the “user annotations” area is only one example of the manner in which secondary and additional media elements may be temporally associated with a primary media element.

When the user clicks on the annotate button 602, they are provided with a pop-up “create a new annotation” screen 608 as shown in FIG. 6b.

The user is provided with editor capabilities and may enter text into the box, to describe their annotation. The annotation is subsequently stored as XHTML.

Referring now to FIG. 6c, the user subsequently enters a URL into the “Autolink” box 610. The URL is a link to the secondary media element (or the additional media element) which will be displayed. It will be understood that the link may reference a webpage, an image, a video file, an audio file, a text file, or any other type of file or information. Moreover, if no link is entered, only the annotation content is displayed in the “Annotation” pane (no auto-link will be displayed in the “Web Page” pane).

Once the user has entered this information, the annotation is created. It should be noted that the temporal association (which may be entered at box 612) is automatically inserted if the user is playing the primary time based media element. Otherwise, the user may choose any suitable time.

When the “Create” button is clicked, the AJAX client calls the servlet to invoke the add annotation function in the eniZone library. This stores the annotation at the remote server, for later retrieval by any user who has permission to view the Zone.

### Advantages

The user interface described herein provides the user with a simple, intuitive yet powerful interface for viewing and receiving a complex arrangement of content.

As the user interface assembles content from a number of disparate sources into a single interface, the user is spared the inconvenience of opening multiple windows or trying to manage (or interact) with content across an entire range of user interfaces and/or devices. The user may focus on the content being displayed rather than attempting to ‘juggle’ different windows or devices.

It will be understood that the user interface described herein may be implemented not only as a standalone application, but may also be distributed across a number of routines, objects and components to achieve the same functionality as the embodiment and the broader invention claimed herein.

It will also be understood that the user interface may be easily arranged to operate on any suitable computing device, including but not limited to, mobile telephones, personal digital assistants, portable and tablet computing devices, television ‘set top’ boxes, or any other device capable of displaying information and/or receiving input from a user. Such variations and modifications would be within the purview of those skilled in the art.

1. A graphical user interface for displaying content, comprising at least two display areas, including a first display area arranged to display a primary time based media element, and at least one second display area arranged to display at least one secondary media element that is temporally associated with the primary time based media element.

2. The graphical user interface in accordance with claim 1, further comprising a third display area, arranged to display annotations which are temporally associated with the time based media element displayed in the first display area.

3. The graphical user interface in accordance with claim 1 or claim 2, further comprising a plurality of additional display areas, each display area being arranged to display at least one additional media element.

4. The graphical user interface in accordance with claim 3, wherein at least one of the additional display areas is arranged to display at least one additional media element which is temporally associated with the primary media element.

5. The graphical user interface in accordance with any one of claims 1 to 4, wherein the user interface is constructed utilising an information set.

6. The graphical user interface in accordance with any one of claims 1 to 5, wherein the information set includes information regarding at least one of the temporal associations of the secondary and/or additional media elements to the primary media element.

7. The graphical user interface in accordance with any one of claims 1 to 6, wherein the user interface further comprises a timing command arranged to poll the information set at predetermined time intervals, to determine whether further secondary media elements and/or additional media elements should be displayed.

8. The graphical user interface in accordance with claim 5, 6 or 7, further comprising a retrieval command arranged to access the information set to retrieve a locator for the at least one of the primary media element, the at least one secondary media element or the at least one tertiary media element.

9. The graphical user interface in accordance with claim 8, wherein the information set includes information regarding a plurality of discrete timing information sets, each timing information set operating independently of each other timing information set.

10. The graphical user interface in accordance with claim 9, wherein each one of the plurality of timing information sets is associated with at least one of the at least one secondary or additional media elements.

11. The graphical user interface in accordance with claim 9 or claim 10, wherein the timing information set includes instructions to invoke a further timing information set.

12. The graphical user interface in accordance with any one of claims 5 to 11, further including a search facility arranged to search the information sets to locate a particular primary, secondary or additional element.

13. The graphical user interface in accordance with any one of claims 1 to 10, wherein the user interface is downloaded as a file which is capable of being executed by web browsing software.

14. The graphical user interface in accordance with claim 15, wherein the file includes Hyper-Text Mark-up Language (HTML) and JavaScript programming information capable of interpretation by web browsing software.

15. The graphical user interface in accordance with any one of claims 1 to 12, wherein the user interface is written in programming code including Asynchronous JavaScript and XML (AJAX) techniques.

16. The graphical user interface in accordance with claim 13, wherein the user interface is a widget arranged to be included in a webpage.

17. The graphical user interface in accordance with any one of claims 5 to 16, wherein the information set is located at a remote location from the user interface.

18. The graphical user interface in accordance with any one of claims 5 to 17, wherein at least one of the primary media element, at least one secondary media element and at least one additional media element is located on a remote server.

19. The graphical user interface in accordance with any one of the preceding claims, wherein the primary media element is one of a video and an audio file.

20. The graphical user interface in accordance with any one of the preceding claims, wherein the at least one secondary media element is any one of a video file, an audio file, a text file and a web page.

21. The graphical user interface in accordance with any one of the preceding claims, wherein the at least one additional media element is any one of a video file, an audio file, a text file and a web page.

22. A method of providing a graphical user interface for displaying content, comprising the steps of providing at least two display areas, including a first display area arranged to display a primary time based media element, and at least one second display area arranged to display at least one secondary media element that is temporally associated with the primary time based media element.

23. The method in accordance with claim 22, further comprising the step of providing a third display area, arranged to display annotations which are temporally associated with the time based media element displayed in the first display area.

24. The method in accordance with claim 22 or claim 23, further comprising the step of providing a plurality of additional display areas, each display area being arranged to display at least one additional media element.

25. The method in accordance with claim 24, comprising the further step of displaying at least one additional media element which is temporally associated with the primary media element in the at least one of the additional display area.

26. The method in accordance with any one of claims 22 to 25, whereby the user interface is constructed utilising an information set.

27. The method in accordance with any one of claims 22 to 26, whereby the information set includes information regarding at least one of the temporal associations of the secondary and/or additional media elements to the primary media element.

28. The method in accordance with any one of claims 22 to 27, comprising the further step of issuing a timing command arranged to poll the information set at predetermined time intervals, to determine whether further secondary media elements and/or additional media elements should be displayed.

29. The method in accordance with claim 26, 27 or 28, further comprising the provision of a retrieval command arranged to access the information set to retrieve a locator for the at least one of the primary media element, the at least one secondary media element or the at least one tertiary media element.

30. The method in accordance with claim 29, whereby the information set includes information regarding a plurality of discrete timing information sets, each timing information set operating independently of each other timing information set.

31. The method in accordance with claim 30, whereby each one of the plurality of timing information sets is associated with at least one of the at least one secondary or additional media elements.

32. The method in accordance with claim 30 or claim 31, whereby the timing information set includes instructions to invoke a further timing information set.

33. The method in accordance with any one of claims 27 to 32, further including the step of providing a search facility arranged to search the information sets to locate a primary, secondary or additional element.

34. The method in accordance with any one of claims 22 to 33, whereby the user interface is downloaded as a file which is capable of being executed by web browsing software.

35. The method in accordance with claim 34, whereby the file includes Hyper-Text Mark-up Language (HTML) and JavaScript programming information capable of interpretation by web browsing software.

36. The method in accordance with any one of claims 22 to 35, whereby the user interface is written in programming code including Asynchronous JavaScript and XML (AJAX) techniques.

37. The method in accordance with claim 36, whereby the user interface is a widget arranged to be included in a webpage.

38. The method in accordance with any one of claims 27 to 37, whereby the information set is located at a remote location from the user interface.

39. The method in accordance with any one of claims 27 to 38, whereby at least one of the primary media element, the at least one secondary media element and the at least one additional media element is located on a remote server.

40. The method in accordance with any one claims 22 to 39, whereby the primary media element is one of a video and an audio file.

41. The method in accordance with any one of claims 22 to 40, whereby the at least one secondary media element is one of a video file, an audio file, a text file and a web page.

42. The method in accordance with any one of claims 22 to 41, whereby the at least one additional media element is any one of a video file, an audio file, a text file and a web page.

43. A computer program arranged to, when executed on a computing system, carry out the method steps of any one of claims 22 to 42.

44. A computer readable medium incorporating a computer program in accordance with claim 43.
